(19) United States
(12) Patent Application Publication
(10) Pub. No.: US 2012/0194416 A1
(43) Pub. Date: Aug. 2, 2012

(54) ELECTRONIC APPARATUS AND METHOD OF CONTROLLING ELECTRONIC APPARATUS

(75) Inventor: Kunio BABA, Oume-shi (JP)

(73) Assignee: KABUSHIKI KAISHA TOSHIBA, Tokyo (JP)

(21) Appl. No.: 13/278,987

(22) Filed: Oct. 21, 2011

(30) Foreign Application Priority Data
Jan. 31, 2011 (JP) 2011-019226

(51) Int. Cl. G09G 5/00

(52) U.S. Cl. 345/156

(57) ABSTRACT

One embodiment provides an electronic apparatus, including: a direction detector disposed in a housing which accommodates electronic components therein and configured to detect a direction of the housing; and a power-saving-mode shift controller configured to control a shift to a power saving mode upon detection of a turned-down direction of the housing.

### CROSS-REFERENCE TO RELATED APPLICATION(S)

This application claims priority from Japanese Patent Application No. 2011-019226 filed on Jan. 31, 2011, the entire contents of which are incorporated herein by reference.

### FIELD

Embodiments described herein relate generally to an electronic apparatus and a method of controlling the electronic apparatus.

### BACKGROUND

In recent years, battery-driven electronic apparatuses of portable type, such as a personal computer (PC) and a smartphone, have come into wide use.

Since these electronic apparatuses of portable type are driven with batteries, they need to reduce power consumption, and many of them include a power saving function.

For example, some of laptop personal computers (PCs) include the function of performing a power saving process such as suspend/shutdown, in accordance with, e.g., a cover closing manipulation even when a user is not especially conscious of power saving.

On the other hand, in recent years, electronic apparatuses such as a plate-shaped PC (slate PC) and a smartphone, each of which does not include a cover, have come into wide use.

The electronic apparatuses not including the cover can not perform the operation which shifts to the power saving process such as suspend/shutdown, in accordance with the user's cover closing manipulation.

Thus, the user himself/herself needs to troublesomely manipulate the shift to the power saving process at a desired timing for the shift to the power saving process.

### BRIEF DESCRIPTION OF DRAWINGS

A general architecture that implements the various feature of the present invention will now be described with reference to the drawings. The drawings and the associated descriptions are provided to illustrate embodiments and not to limit the scope of the present invention.

FIG. 1 illustrates an electronic apparatus according to an embodiment.

FIGS. 2A, 2B and 2C illustrate the “turned-down direction” and the “faced-up direction” of the electronic apparatus according to the embodiment.

FIG. 3 illustrates a system configuration of the electronic apparatus according to the embodiment.

FIG. 4 illustrates an operation of the electronic apparatus according to the embodiment.

FIG. 5 illustrates another example of an electronic apparatus according to the embodiment.

### DETAILED DESCRIPTION

In general, one embodiment provides an electronic apparatus, including: a direction detector disposed in a housing which accommodates electronic components therein and configured to detect a direction of the housing; and a power-saving-mode shift controller configured to control a shift to a power saving mode upon detection of a turned-down direction of the housing.

Embodiments will be described with reference to the drawings.

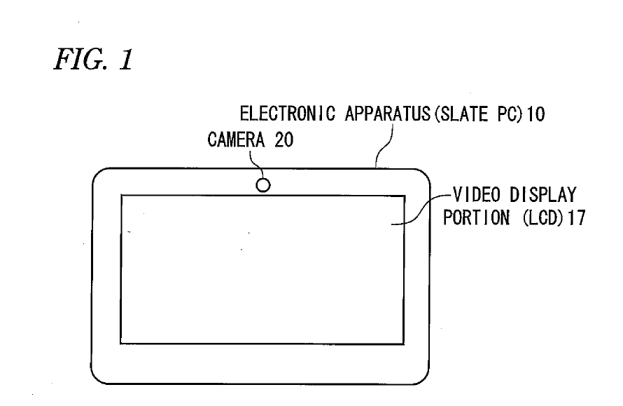

FIG. 1 illustrates a slate PC, as an example of an electronic apparatus according to the embodiment.

The electronic apparatus (slate PC) 10 includes a video display portion 17 and a camera 20.

FIG. 1 illustrates a state where the video display portion 17 of the electronic apparatus (slate PC) 10 faces to a user. As shown in FIG. 1, the video display portion 17 is disposed in the housing of the electronic apparatus (slate PC) 10.

The camera 20 is also disposed in the housing of the electronic apparatus (slate PC) 10 in juxtaposition with the video display portion 17.

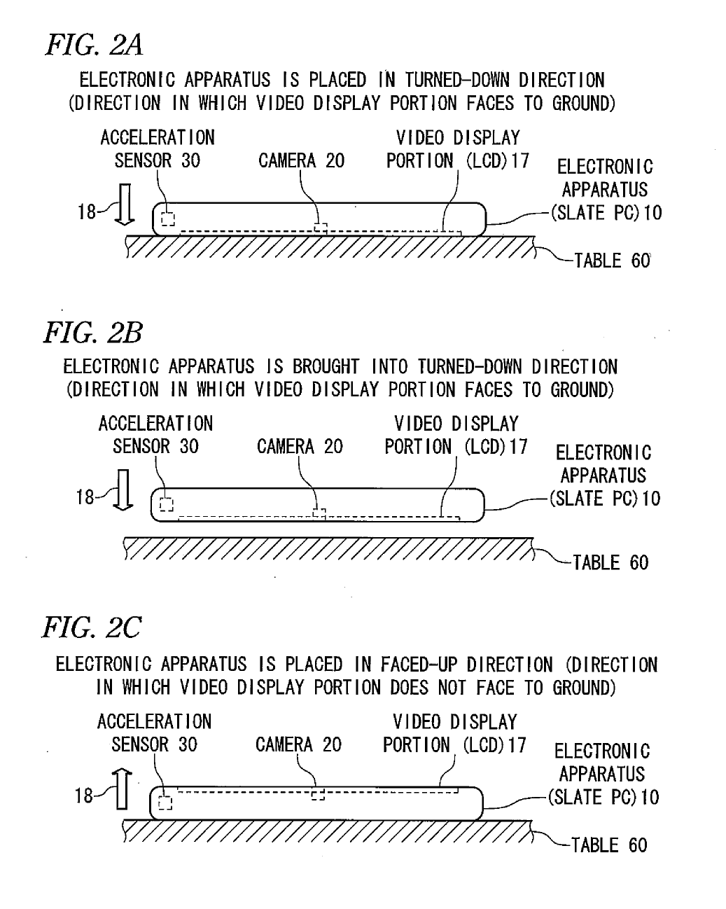

FIGS. 2A, 2B and 2C illustrate the “faced-up direction” and the “turned-down direction” of the electronic apparatus according to the embodiment.

An acceleration sensor 30 is disposed within the housing of the electronic apparatus 10. As shown in FIGS. 2A to 2B, for example, the electronic apparatus 10 is placed on a table 60 such that the video display portion 17 faces in a given direction 18, in accordance with the usage condition.

In this embodiment, the acceleration sensor 30 operates during the operation of the electronic apparatus 10.

The electronic apparatus 10 can detect the direction of the housing of this electronic apparatus 10 (that is, the direction of the electronic apparatus 10 itself) with the acceleration sensor 30, and can control a shift to a power saving mode based on the detected direction.

Also, the electronic apparatus 10 can detect the shake of the electronic apparatus 10 with the acceleration sensor 30, and can control the shift to the power saving mode when the shake of this electronic apparatus 10 is small, for example.

Here, an example of the power saving mode of the electronic apparatus 10 will be described.

For example, the power saving modes of the electronic apparatus 10 includes a function called “suspend” or “standby”.

The suspend is the function of storing the state of the electronic apparatus such as the computer, immediately before turning OFF the power source of this electronic apparatus, whereby a job can be restarted from the state immediately before the turn-OFF of the power source when this power source has turned ON next.

Thus, a battery-driven notebook personal computer, for example, is permitted to suppress the consumption of electric power while storing a job state, in a case where the use of the computer (electronic apparatus) is once interrupted. This operation is such that, at the interruption, the job state is stored in a memory in the power saving mode, and that, at the restart, the power saving mode is released so as to return into the state immediately before the turn-OFF of the power source.

In this way, a time period and a labor are less expended, and the power consumption can be reduced more, than in a case where an OS and application software are fully ended and started.

The power saving modes of the electronic apparatus 10 also includes a function called “hibernation”.

The hibernation function differs from the suspend function in the point that a job state is stored in a hard disk.

And, “shutdown” is the function of turning OFF the power source of the electronic apparatus.

FIG. 2A illustrates a state where the electronic apparatus is placed in the “turned-down direction” (the direction in which the video display portion faces to the ground).

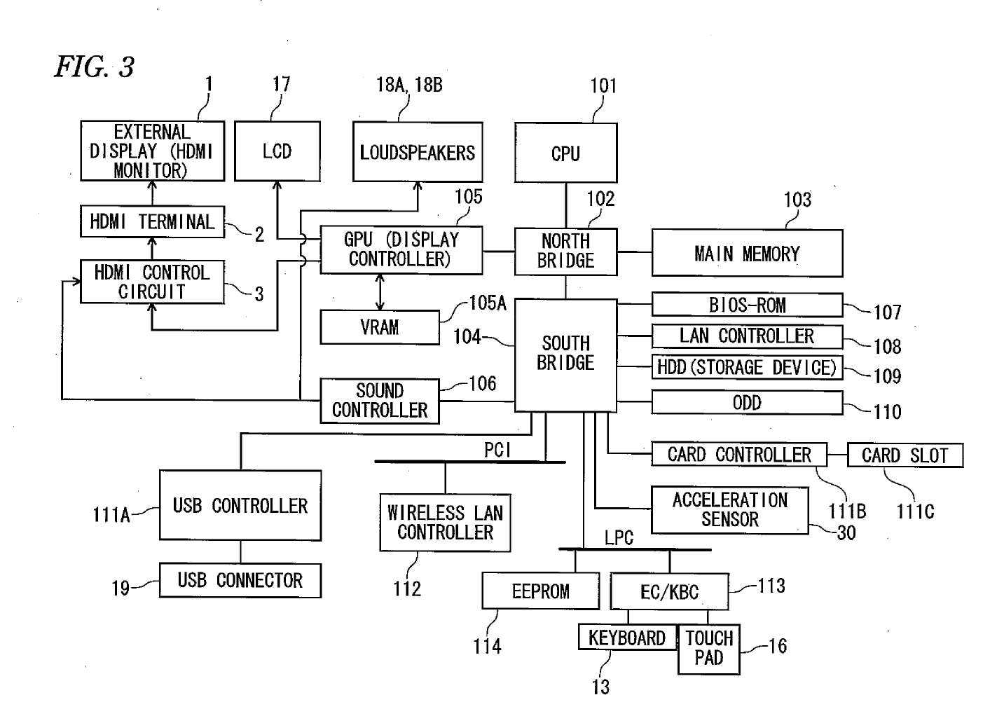

Although not especially illustrated, for example, electronic components as illustrated in FIG. 3 are accommodated within the housing of the electronic apparatus 10.

As stated above, the video display portion 17 configured of an LCD or the like, and the camera 20 are disposed in the housing of the electronic apparatus 10. And, the acceleration sensor 30 is disposed in the housing of the electronic apparatus 10 as shown in FIG. 2A, so as to detect the direction of the housing of the electronic apparatus 10 (that is, the direction of the electronic apparatus 10 itself).

In FIG. 2A, the electronic apparatus (slate PC) 10 is placed on the table 60 in the direction in which the video display portion (LCD) 17 faces to the ground as indicated by the numeral 18, that is, in the “turned-down direction”.

In this embodiment, the direction in which the video display portion (LCD) 17 faces to the ground is called the direction in which the housing of the electronic apparatus 10 (that is, the electronic apparatus 10 itself) is turned down (the “turned-down direction”).

In this embodiment, the electronic apparatus 10 detects the direction of the housing of the electronic apparatus 10 with the acceleration sensor 30, and controls the shift to the power saving mode in a case where the “turned-down direction” as shown in FIG. 2A has been detected.

For example, the electronic apparatus 10 may control the shift to the power saving mode when the electronic apparatus 10 has been placed on the table 60 or the like in the “turned-down direction” and the shake detected by the acceleration sensor 30 is small.

Here, the acceleration sensor 30 according to this embodiment will be described.

In principle, the acceleration sensor 30 measures an acceleration by grasping the positional change of a mass with respect to a speed increase.

For example, there are a mechanical-type acceleration sensor, an optical-type acceleration sensor and a semiconductor-type acceleration sensor. For example, the acceleration sensors are used to measure accelerations in a scientific experiment, a seismometer, etc., and they are also used in a pedometer and in a cellphone to determine the vertical direction of the screen thereof.

While a three-axis acceleration sensor is exemplified as the acceleration sensor 30 in this embodiment, any other sensor can also be employed as long as it can measure the direction of the electronic apparatus 10.

The “three-axis acceleration sensor” can measure accelerations in the three directions of X-, Y- and Z-axes, with one device. This is a kind of MEMS (micro-electro-mechanical systems) sensor.

The three-axis acceleration sensors include, for example, a piezoresistive type three-axis acceleration sensor, an electrostatic capacitance type three-axis acceleration sensor, and a thermosensitive type three-axis acceleration sensor.

FIG. 2B illustrates a state where the electronic apparatus is brought into the “turned-down direction” (the direction in which the video display portion faces to the ground).

As in FIG. 2A, the electronic apparatus (slate PC) 10 is in the direction in which the video display portion (LCD) 17 faces to the ground (that is, in which the housing of the electronic apparatus 10 (the electronic apparatus 10 itself) is in the “turned-down direction”). However, the housing of the electronic apparatus 10 is not placed on the table 60 or the like.

Also here, in the same manner as in the foregoing, the electronic apparatus 10 controls the shift to the power saving mode in a case where the “turned-down direction” of the housing of this electronic apparatus 10 has been detected by the acceleration sensor 30.

On the other hand, for example, when the user looks up at the electronic apparatus (slate PC) 10 while lying on his/her back, the electronic apparatus (slate PC) 10 might also fall into the “turned-down direction”.

In such a case, the shift of the electronic apparatus 10 to the power saving mode will be sometimes undesirable.

Accordingly, for example, the electronic apparatus 10 is configured not to shift to the power saving mode in the state as shown in FIG. 2B, but shift to the power saving mode in the state as shown in FIG. 2A. Thus, the electronic apparatus 10 may be configured so as to control the shift to the power saving mode when this electronic apparatus 10 has been placed on the table 60 or the like in the “turned-down direction” and the fact that the shake is small is detected through a detection result of the acceleration sensor 30.

FIG. 2C illustrates a state where the housing of the electronic apparatus 10 (the electronic apparatus 10 itself) is held in a direction other than the “turned-down direction”. Here, for example, the electronic apparatus 10 is placed in the faced-up direction (the direction in which the video display portion 17 does not face to the ground).

FIG. 3 illustrates a system configuration of the electronic apparatus according to the embodiment.

For example, at least some of the illustrated components are accommodated within the electronic apparatus (slate PC) 10.

The electronic apparatus (slate PC) 10 includes a CPU (central processing unit) 101, a north bridge 102, a main memory 103, a south bridge 104, a GPU (Graphic Processing Unit) 105, a VRAM (video RAM: random access memory) 105A, a sound controller 106, a BIOS-ROM (basic input/output system-read only memory) 107, a LAN (local area network) controller 108, a hard disk drive (HDD (storage device)) 109, an optical disk drive (ODD) 110, a USB controller 111A, a card controller 111B, a wireless LAN controller 112, an embedded controller/keyboard controller (EC/KBC) 113, an EEPROM (electrically erasable programmable ROM) 114, etc.

The CPU 101 controls the operations of the various portions within the electronic apparatus (slate PC) 10.

The CPU 101 runs a BIOS which is stored in the BIOS-ROM 107. The BIOS is a program for a hardware control.

The north bridge 102 is a bridge device which serves for the connection between the local bus of the CPU 101 and the south bridge 104. A memory controller for controlling access to the main memory 103 is also built in the north bridge 102. The north bridge 102 also has the function of executing communications with the GPU 105 through, for example, a serial bus of PCI EXPRESS STANDARD.

The GPU 105 is a display controller which controls the video display portion (LCD) 17 that is used as the display monitor of the electronic apparatus (slate PC) 10.

A display signal generated by the GPU 105 is sent to the video display portion (LCD) 17. The GPU 105 can also deliver a digital video signal to an external display 1 through an HDMI control circuit 3 and an HDMI terminal 2.

The HDMI terminal 2 is the connection terminal of the above external display. This HDMI terminal 2 can deliver a non-compressed digital video signal and a digital audio signal to the external display 1 such as a TV receiver, with a single cable. The HDMI control circuit 3 is an interface for delivering the digital video signal to the external display 1 called “HDMI monitor”, through the HDMI terminal 2.

The south bridge 104 controls individual devices on a PCI (Peripheral Component Interconnect) bus, and individual devices on an LPC (Low Pin Count) bus. The south bridge 104 has a built-in IDE (Integrated Drive Electronics) controller for controlling the HDD 109 and the ODD 110.

Further, the south bridge 104 also has the function of executing communications with the sound controller 106.

The sound controller 106 is a sound source device, and it outputs audio data to-be-reproduced to a loudspeaker 18A or 18B or the HDMI control circuit 3. The LAN controller 108 is a wired communication device which executes the wired communications of, for example, IEEE 802.3 Standard, whereas the LAN controller 112 is a wireless communication device which executes the wireless communications of, for example, IEEE 802.11g Standard. The USB controller 111A executes communications with an external apparatus compatible with, for example, USB 2.0 Standard (as is connected through a USB connector 19).

For example, the USB controller 111A is used for receiving an image data file which is stored in, for example, a digital camera. The card controller 111B executes the write and read of data into and from an SD card or the like memory card which is inserted into the card slot 111C provided in the body 11 of the computer (notebook PC).

The EC/KBC 113 is a one-chip microcomputer in which the embedded controller for power management, and the keyboard controller for controlling a keyboard 13 and a touch pad 16 are integrated. This EC/KBC 113 has the function of turning ON/OFF the power source of the electronic apparatus (slate PC) 10, in accordance with the manipulation of a power button 14 by the user.

The display control in this embodiment is performed such that the CPU 101, for example, runs a program recorded in the main memory 103, the HDD 109, or the like.

In this embodiment, the electronic apparatus 10 includes the above-described acceleration sensor 30, in the housing.

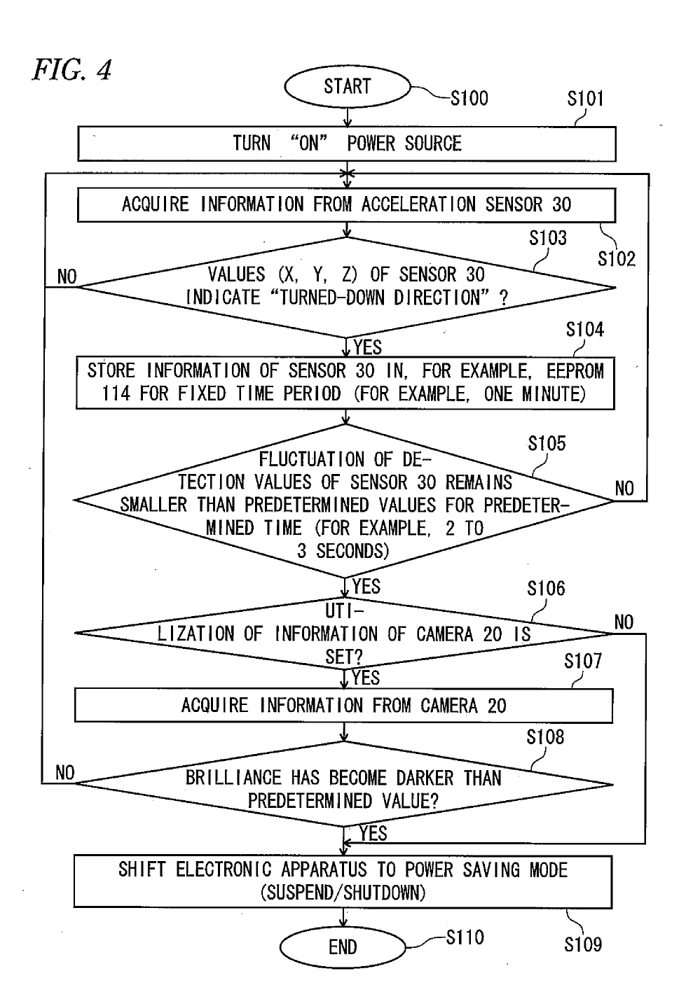

FIG. 4 illustrates an operation of the electronic apparatus according to the embodiment.

Reference sign S100 is a start step. Subsequently, the flow proceeds to a step S101.

The step S101 is a step at which the user turns ON the power source of the electronic apparatus 10. Subsequently, the flow proceeds to a step S102.

The step S102 is a step at which information is acquired from the acceleration sensor 30 that measures an acceleration by grasping the positional change of a mass based on a speed increase. Subsequently, the flow proceeds to a step S103.

The step S103 is a step at which the CPU 101, for example, discriminates if the housing of the electronic apparatus 10 (the electronic apparatus 10 itself) is in the “turned-down direction”, by using the information acquired from the acceleration sensor 30 (the detection values (X, Y, Z) of the sensor 30). In case of the discrimination that the housing of the electronic apparatus 10 (the electronic apparatus 10 itself) is in the “turned-down direction”, the flow proceeds to a step S104 (“Yes” at the step S103). More specifically, when the detection values of the acceleration sensor 30 have become preset values with which the electronic apparatus 10 is judged to be in the “turned-down direction” (for example, “0” in X- and Y-directions, and “10” or less in a Z-direction), it is discriminated that the video display portion 17 has been brought into the “turned-down direction” which is the direction faces to the ground.

In case of the discrimination that the housing of the electronic apparatus 10 (the electronic apparatus 10 itself) is not in the “turned-down direction”, the flow proceeds to the step S102 so as to repeat the above processing (“No” at the step S103).

The step S104 is a step at which the information items of the acceleration sensor 30 (the detection values of the acceleration sensor 30) are stored in, for example, the EEPROM 114 of the electronic apparatus 10 for a fixed time period (for example, for one minute). Subsequently, the flow proceeds to a step S105.

The step S105 is a step at which the CPU 101, for example, receives the detection values of the acceleration sensor 30 as stored in the EEPROM 114 for the fixed time period and then discriminates if a degree of shake is smaller than the predetermined value for a predetermined time period (for example, for 2 to 3 seconds) (that is, if the shake is near a standstill state).

In a case where the shake is smaller than the predetermined value for the predetermined time period and where the state of the housing of the electronic apparatus 10 is discriminated to be near the standstill state, the flow proceeds to a step S106 (“Yes” at the step S105). In a case where the shake is smaller than the predetermined value for the predetermined time period and where the state of the housing of the electronic apparatus 10 is not discriminated to be near the standstill state, the flow proceeds to the step S102 so as to repeat the above processing (“No” at the step S105).

The step S106 is a step which is performed in a case where the utilization of information on a brilliance acquired from the camera 20 is previously set though no illustration is especially made. In the case where the utilization of the information of the camera 20 is previously set, the flow proceeds to a step S107 (“Yes” at the step S106). In a case where the utilization of the information of the camera 20 is not previously set, the flow proceeds to a step S109 (“No” at the step S106).

The step S107 is a step at which the information is acquired from the camera 20. Here, for example, the information on the brilliance is acquired. Subsequently, the flow proceeds to a step S108.

The step S108 is a step at which the information (value) on the brilliance as acquired from the camera 20 is compared with a predetermined value so as to discriminate if the value acquired from the camera 20 is smaller than the predetermined value, that is, if the brilliance acquired from the camera 20 has become darker than the predetermined value. In a case where the information on the brilliance as acquired from the camera 20 is discriminated to have become darker than the predetermined value, the flow proceeds to a step S109 (“Yes” at the step S108). In a case where the information on the brilliance as acquired from the camera 20 is not discriminated to have become darker than the predetermined value, the flow returns to the step S102 so as to repeat the above processing (“No” at the step S108).

The step S109 is a step which shifts the electronic apparatus 10 to the power saving mode, for example, suspend of shutdown. Subsequently, the flow proceeds to a step S110.

The step S110 is an end step, at which the processing here is ended.

In this embodiment, whether the user has intentionally placed the electronic apparatus 10 in the “turned-down direction” for example or not is discriminated at the steps S104 and S105.

In addition, the electronic apparatus 10 should preferably be prevented from shifting to the power saving mode such as the suspend, in a case, for example, where the user has unintentionally inclined this electronic apparatus downwards for a moment. Accordingly, the values of the acceleration sensor 30 are stored in a buffer for a fixed time (for example, for one minute), and on condition that the detection values of the sensor 30 do not change for a predetermined period (for several seconds to 10 seconds or so), the suspend/shutdown processing as the power saving mode is performed.

For example, the detection values of the acceleration sensor 30 are always fluctuating little, and immediately after the electronic apparatus 10 has been moved, some time period is required until the detection values of the acceleration sensor 30 settle.

In this embodiment, therefore, the electronic apparatus 10 is judged to “have been placed in the turned-down direction”, when the detection values have remained for a fixed time within the fluctuation range (previously set value) with which the state where the electronic apparatus 10 is placed on the table 60 or the like (where the body of the electronic apparatus does not move) can be judged.

In a case where the electronic apparatus 10 has become clearly non-downward, the settlement of the acceleration in the acceleration sensor 30 need not be sensed.

Further, the electronic apparatus 10 is so configured that the settlement condition of the shake of the acceleration sensor 30 (fluctuation of the detection values) for the fixed period is confirmed as stated above. Thus, the electronic apparatus 10 can also be prevented from becoming the suspend during the use thereof in a case where the user keeps the electronic apparatus downward, for example, where he/she is using this electronic apparatus while lying down. In this case, the detection values of the acceleration sensor 30 fluctuate more than in the placed state of the electronic apparatus 10.

As described above, in this embodiment, the electronic apparatus 10 can be easily shifted to the power saving mode (the suspend/shutdown or the like) such that the user performs the manipulation of “turning down” the video display device 17 in the housing of the electronic apparatus 10.

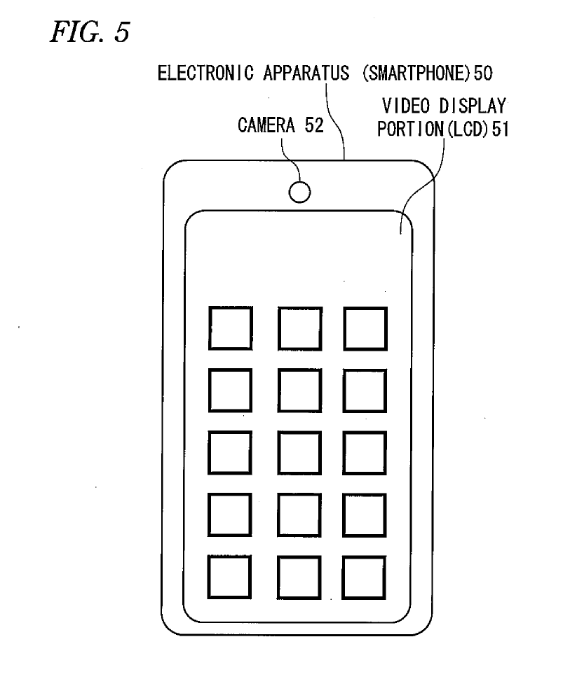

FIG. 5 illustrates a smartphone, as another example of an electronic apparatus according to the embodiment.

In this example, a video display portion 51 is disposed in the housing of the electronic apparatus (smartphone) 50.

And, a camera 52 is disposed in the housing of the electronic apparatus (smartphone) 50, and it is juxtaposed with the video display portion 51.

Further, the electronic apparatus (smartphone) 50 includes an acceleration sensor though no illustration is especially made.

The electronic apparatus (smartphone) 50 detects the direction of the housing of the electronic apparatus 10 by the acceleration sensor not shown, and controls the shift to the power saving mode in a case where the “turned-down direction” has been detected, in the same manner as in the foregoing.

The electronic apparatus 50 may control the shift to the power saving mode when the electronic apparatus (smartphone) 50 has been placed on a table 60 or the like in the “turned-down direction” and the shake detected by the acceleration sensor is small.

According to the above-described embodiment, the electronic apparatus of the type which does not include any cover is permitted to easily shift to the power saving mode (suspend/shutdown or the like).

It is therefore permitted to enhance the convenience of the user.

The embodiment is not restricted to the above description itself. For example, the embodiment can be changed by variously modifying the components within a scope of the invention.

1. An electronic apparatus, comprising:
a direction detector in a housing configured to accommodate electronic components therein, the direction detector configured to detect an orientation of the housing; and
a power-saving-mode controller configured to cause at least one electronic component to enter a power saving mode upon detection of a turned-down orientation of the housing.

2. The apparatus of claim 1, further comprising:
a video display in the housing, the video display configured to display a video,
wherein, when the housing is in the turned-down orientation, the video display portion faces to the ground.

3. The apparatus of claim 1, wherein the electronic apparatus is configured to enter the power saving mode when the power-saving-mode controller detects that the housing is in the turned-down orientation and that and a measured shake is less than a first value for a first time.

4. The apparatus of claim 1, further comprising:
a brightness detector disposed in the housing and configured to detect a brightness.

5. The apparatus of claim 4, wherein the brightness detector is juxtaposed with the video display.

6. The apparatus of claim 1, wherein the electronic apparatus is configured to enter the power saving mode when the housing is on an object in the turned-down orientation.

7. The apparatus of claim 4, wherein the electronic apparatus is configured to enter the power saving mode when the power-saving-mode controller detects that the housing is in the turned-down orientation, and wherein the brightness detector detects a brightness below a threshold brightness.

8. A method of controlling an electronic apparatus, comprising:
detecting an orientation of a housing which accommodates electronic components therein; and
controlling at least one electronic component to enter a power saving mode upon detection of a turned-down orientation of the housing.
